(19) United States
(12) Patent Application Publication
(10) Pub. No.: US 2024/0326058 A1
(43) Pub. Date: Oct. 3, 2024

(54) TUBE ADAPTERS FOR SAMPLE RACKS

(71) Applicant: BECTON, DICKINSON AND COMPANY, Franklin Lakes, NJ (US)

(72) Inventors: Alyssa Shedlosky, Reisterstown, MD (US); Ammon David Lentz, York, PA (US); Michael T. VanSickler, Catonsville, MD (US); Christopher John Tesluk, Baltimore, MD (US); Rohini Valluru Rao, Baltimore, MD (US)

(73) Assignee: BECTON, DICKINSON AND COMPANY, Franklin Lakes, NJ (US)

(21) Appl. No.: 18/293,849

(22) PCT Filed: Aug. 8, 2022
(86) PCT No.: PCT/US2022/039692

§ 371 Date: Jan. 31, 2024

Related U.S. Application Data
(60) Provisional application No. 63/231,105, filed on Aug. 9, 2021.

(51) Int. Cl. B01L 9/06

(52) U.S. Cl. CPC B01L 9/06; B01L 2200/023; B01L 2200/025; B01L 2300/0609

(57) ABSTRACT

Adapters that enable a change in the types of sample collection devices that may be inserted into and stored in sample collection device racks. The adapters are either individual adapters that fit into a rack receptacle for receiving a sample collection device, typically a tube or cylindrical container, or an array of adapters held together by connecting members that can be disposed on a sample collection device rack. With the adapters disposed in the rack receptacle, that receptacle, sized to receive securely a sample collection device of a first size, can now receive, securely, a sample collection device of a second size. The adapters are removable and washable so that racks can be modified to receive sample containers of different sizes.

### CROSS REFERENCE TO RELATED APPLICATIONS

The present application claims priority to and the benefit of U.S. Provisional Application 63/231,105, which was filed on Aug. 9, 2021, and which is incorporated by reference herein.

### TECHNICAL FIELD

The present technology relates to adapters that enable tube racks, such as sample collection tube racks, to receive and store different types/sizes of containers or tubes, such as sample collection tubes.

### BACKGROUND

In laboratory and other settings, racks may be used for holding or retaining collection tubes or vials that are used for collecting and storing various types of samples (e.g., blood, urine, etc.) The sample collection tubes may be inserted into and retained by the rack, which includes a plurality of chambers or pockets for receiving individual sample collection tubes for convenient transport and/or storage of the sample collection tubes. Existing sample collection tube racks are designed to retain sample collection tubes of a single type having the same dimensions (shape, length, diameter, etc.) However, many different types of sample collection tubes having varying dimensions exist for use in laboratory and other settings. Thus, when using different types of sample collection tubes, users are forced to keep many different sample collection tube racks for each type of sample collection tube used. This process is inefficient and costly. Therefore, a need exists for alternative means for storing sample collection tubes in sample collection tube racks.

### BRIEF SUMMARY

Adapters insertable into a rack that enable a rack with a receptacle sized to receive sample containers such as sample collection tubes of a different size or shape than the rack receptacles. Adapters/inserts that are inserted into removably retained in tube racks are described herein.

According to one aspect of the present disclosure, an adapter is provided for receiving and retaining a tube in a tube rack. The adapter comprises a first end and a second end, a tubular body extending from the first end to the second end, the tubular body including an interior, a rim formed on the first end of the insert and including a first beveled surface, and an aperture providing access to the interior of the tubular body. The interior of the tubular body is dimensioned to receive and retain the tube. When the second end of the adapter is inserted into a chamber of a receptacle of the tube rack, the first beveled surface is configured to contact a beveled surface defining an opening of the receptacle to position the adapter in coaxial alignment with the chamber.

In one example, the rim includes a second beveled surface defining the aperture. The second beveled surface is configured to guide the tube into the interior of the tubular body.

In one example, the adapter has at least one rib extending from an outer wall of the tubular body toward an exterior of the adapter. At least a portion of the at least one rib is configured to contact an interior wall of the chamber of the tube rack to maintain the coaxial alignment between the adapter and the chamber and retain the adapter in the chamber.

In one example, the at least one rib includes a first edge extending in parallel with a central longitudinal axis of the tubular body. At least a portion of the first edge is configured to contact the interior wall of the chamber of the tube rack.

In one example, the at least one rib further includes a second edge that tapers from the first edge to the outer wall of the tubular body. The second edge is configured to guide the adapter into the chamber of the tube rack.

In one example, the at least one rib is a deformable rib comprising a slot.

In one example, the at least one rib has a plurality of ribs spaced apart equidistantly about an outer circumference of the tubular body.

In one example, the chamber of the tube rack has a first diameter for receiving a first type of tube and the interior of the adapter has a second diameter for receiving a second type of tube. The first diameter is larger than the second diameter.

In one example, the first beveled surface of the adapter is shaped to correspond to a shape of the beveled surface of the receptacle of the tube rack.

In one example, the tube is a sample collection tube and the tube rack is a sample collection tube rack.

In one example, the adapter is made of Acrylonitrile Butadiene Styrene.

According to another aspect of the present disclosure, an apparatus is provided for receiving and retaining one or more tubes in a tube rack. The apparatus comprises an array of a plurality of adapters and at least one connection member for the plurality of adapters in the array. The plurality of adapters each has a first end and a second end, and a tubular body extending from the first end to the second end and including an interior. The adapter has a rim formed on the first end of the tubular body extending from the first end that includes an entry aperture providing access to the interior of the tubular body. The interior of the tubular body is dimensioned to receive and retain a tube. The at least one connection member joins the plurality of adapters such that each adapter of the plurality of adapters aligns with and is insertable into a chamber of a corresponding receptacle of the tube rack.

In one example, the apparatus is insertable into the tube rack.

In one example, the tube is a sample collection tube and the tube rack is a sample collection tube rack.

In one example, the rim of each adapter in the array of adapters includes a first beveled surface and the second end of each adapter in the array of adapters is configured for insertion into a corresponding chamber of the tube rack. The first beveled surface of each adapter is configured to contact a beveled surface of each corresponding chamber to position each adapter in coaxial alignment with the corresponding chamber in the tube rack.

In one example, the rim of each adapter in the array of adapters further includes a second beveled surface disposed around the entry aperture, the second beveled surface being configured to guide the tube into the interior of the tubular body when inserted therein.

In one example, each adapter includes at least one rib extending from an outer wall of the tubular body toward an exterior of the adapter and wherein at least a portion of the at least one rib is configured to contact an interior wall of the corresponding chamber and to maintain the coaxial alignment between the adapter and the chamber and to retain the adapter in the chamber.

In one example, the at least one rib further comprises a plurality of ribs spaced apart equidistantly about an outer circumference of the tubular body.

In one example, the at least one connection member is a sheet of material that connects the plurality of adapters.

In one example, the sheet is bendable.

In one example, the rib of each adapter includes a beveled surface disposed around the aperture. The beveled surface is configured to guide the tube into the interior of the tubular body.

In one example, each chamber of the tube rack has a first diameter for receiving a first type of tube and the interior of each adapter has a second diameter for receiving a second type of tube. The first diameter is larger than the second diameter.

### BRIEF DESCRIPTION OF DRAWINGS

FIG. 1A is a perspective view of an insert in accordance with the present technology.

FIG. 1B is a front view of the insert of FIG. 1A in accordance with the present technology.

FIG. 2A is a perspective view of a plurality of the inserts of FIG. 1A being used with sample collection tubes and a sample collection tube rack in accordance with the present technology.

FIG. 2B is the perspective view of FIG. 1A with the sample collection tube rack shown in phantom in accordance with the present technology.

FIG. 2C is a cross-sectional view of the perspective view of FIG. 2A in accordance with the present technology.

FIG. 2D is a top view of the perspective view of FIG. 2A in accordance with the present technology.

FIG. 3A is a perspective view of another insert in accordance with the present technology.

FIG. 3B is a side view of the insert of FIG. 3A in accordance with the present technology.

FIG. 3C is a bottom view of the insert of FIG. 3A in accordance with the present technology.

FIG. 4A is a perspective view of the insert of FIG. 3A being used with sample collection tubes and a sample collection tube rack in accordance with the present technology.

FIG. 4B is the perspective view of FIG. 4A with the sample collection tube rack shown in phantom in accordance with the present technology.

FIG. 4C is a cross-sectional view of the perspective view of FIG. 4A in accordance with the present technology.

FIG. 4D is a top view of the insert of the perspective view of FIG. 4A in accordance with the present technology.

FIG. 5A is a perspective view of another insert in accordance with the present technology.

FIG. 5B is a side view of the insert of FIG. 5A in accordance with the present technology.

FIG. 5C is a bottom view of the insert of FIG. 5A in accordance with the present technology.

FIG. 6A is a perspective view of the insert of FIG. 5A being used with sample collection tubes and a sample collection tube rack in accordance with the present technology.

FIG. 6B is the perspective view of FIG. 6A with the sample collection tube rack shown in phantom in accordance with the present technology.

FIG. 6C is a cross-sectional view of the perspective view of FIG. 5A in accordance with the present technology.

### DETAILED DESCRIPTION

Embodiments of the present disclosure are described in detail with reference to the drawing figures wherein like reference numerals identify similar or identical elements. It is to be understood that the disclosed embodiments are merely examples of the disclosure, which may be embodied in various forms. Well-known functions or constructions are not described in detail to avoid obscuring the present disclosure in unnecessary detail. Therefore, specific structural and functional details disclosed herein are not to be interpreted as limiting, but merely as a basis for the claims and as a representative basis for teaching one skilled in the art to variously employ the present disclosure in virtually any appropriately detailed structure.

Tubes, as used herein, refers to a container of any shape or size that is configured to receive a liquid sample. Such containers are referred to by a variety of terms including vials, receptacles, containers, etc. Such containers are typically cylindrical and can have flat or rounded bottoms.

Adapters for tubes or vials are disclosed herein. In some embodiments, the adapters can be inserted into a rack receptacle to receive tubes or vials of various sizes or types that cannot be held by the rack receptacle itself. In certain non-limiting exemplary embodiments, the tubes or vials disclosed herein can be sample collection tubes, sample storage tubes, or sample processing tubes, etc. Accordingly, the racks can be any racks capable of receiving such tubes or vials. In an exemplary embodiment, the tube is a sample collection tube, and the rack is a sample receptacle rack. The racks receive the adapters and the receptacles in the rack, which are configured to receive sample tubes or vials of a first size and/or configuration can now receive sample tubes or vials of a different size and/or configuration. The rack receptacles of the first size are larger than the adapter receptacles of the second size because the receptacles of the adapter sit within the receptacles of the rack. Some non-limiting examples of racks are described in commonly owned International Application No. PCT/US2017/018358 (published as WO/2017/143182), which is incorporated by reference herein in its entirety. Another non-limiting example of racks includes the rack for SurePath™ collection vials. One skilled in the art is aware that racks can be used to store and transport a variety of consumables in addition to tubes/containers. For example, in automated platforms for performed diagnostic analysis of biological samples, consumable pipette tips are used to aspirate and dispensed sample and/or reagents from/into sample containers. Such consumable pipette tips are provided in a tray, and racks can be used to transport/store pipette tip trays in the automated apparatus.

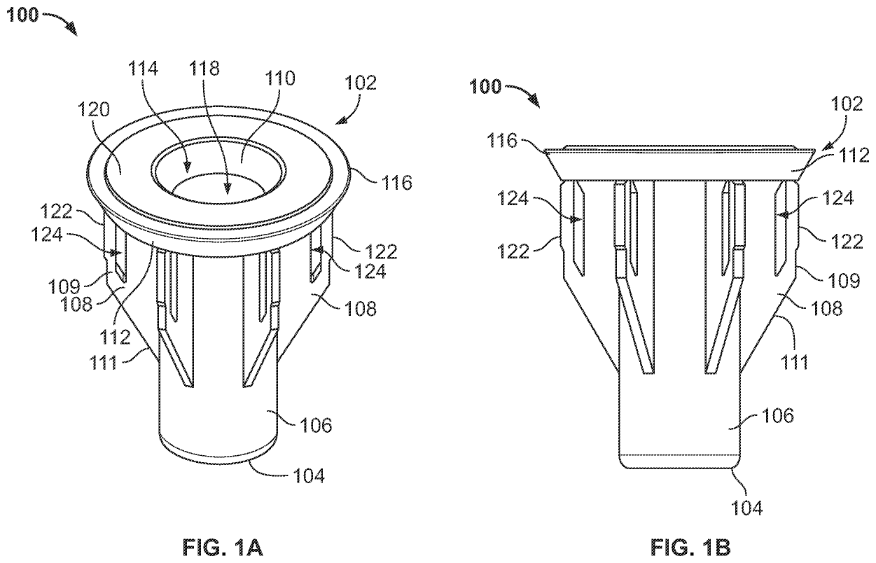

In one embodiment, an individual adapter for use with a tube rack, such as a sample collection tube rack, is provided in accordance with the present technology. For example, referring to FIGS. 1A and 1B, an adapter 100 for use with a sample collection tube rack is shown in accordance with the present technology. Adapter 100 includes first end 102, second end 104, and tubular body 106. Moreover, adapter 100 includes one or more physical features configured to enable adapter 100 to receive and secure a sample collection tube or vial and interface with a sample collection tube rack such that adapter 100 is secured in the sample collection tube rack. As described in greater detail below, adapter 100 is configured to enable a sample collection tube rack to receive a different size and/or configuration of sample collection tubes or vials than the receptacles in the sample collection tube rack were configured to receive.

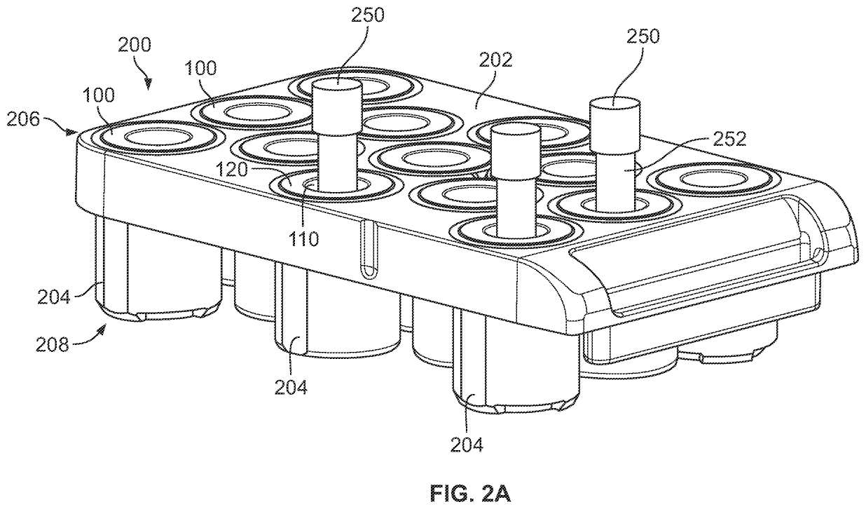

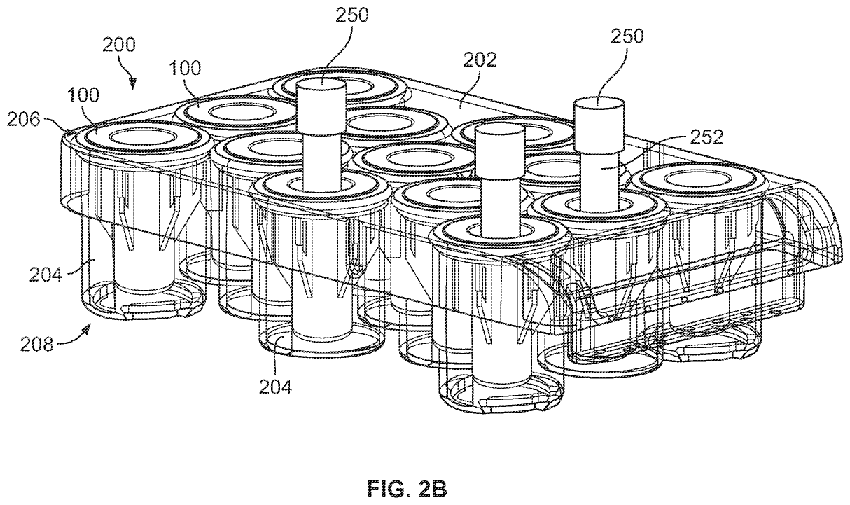

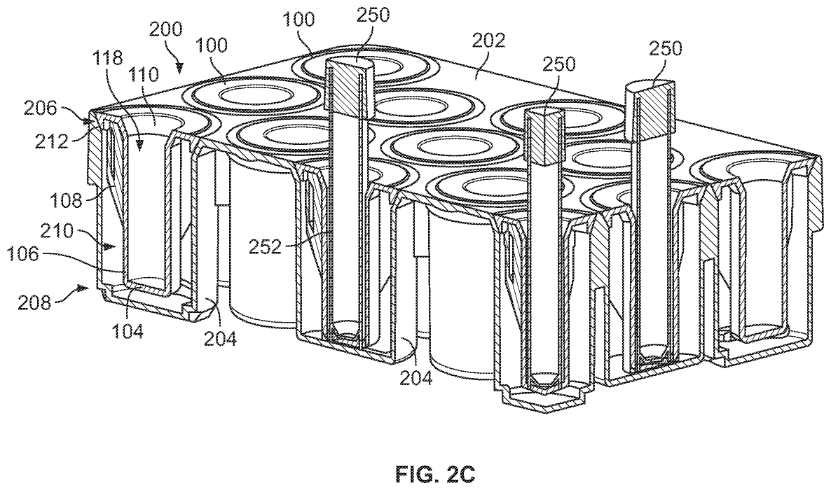

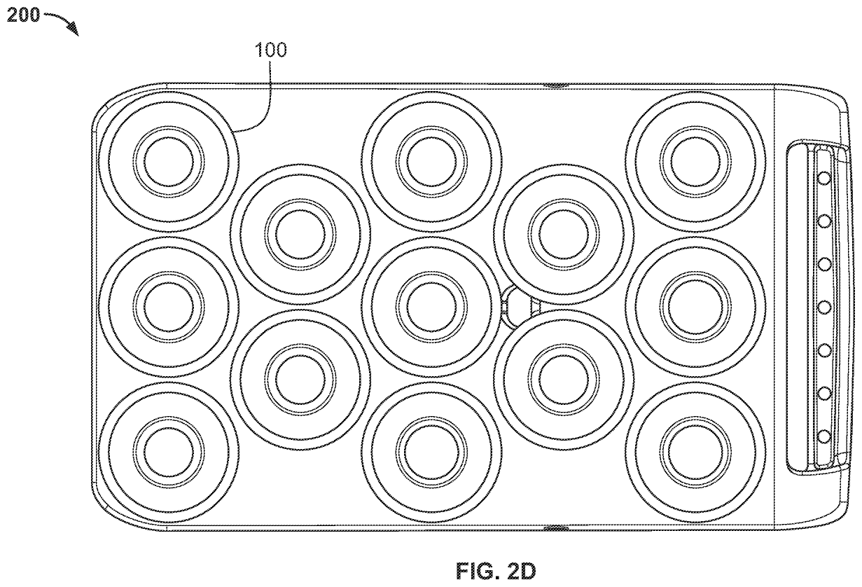

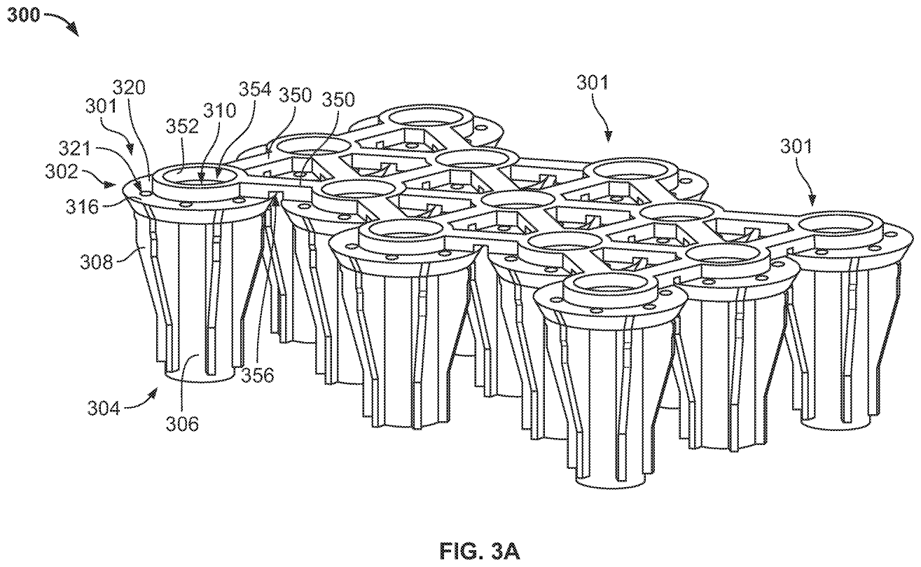

For example, in one embodiment, adapter 100 includes ribs or spacers 108 and rim 116. Rim 116 is formed at the first end 102 of adapter 100 and is configured in a circular or disc shape. Rim 116 includes a top surface 120, beveled surfaces or chamfers 110, 112, and an aperture 114 circumscribed by beveled surface 110. Beveled surface 112 is disposed a predetermined distance from the outer wall of tubular body 106. Rim 116 is attached to an open end of tubular body 106 such that aperture 114 aligns with the open end of tubular body 106 and provides access to the interior 118 of tubular body 106, which is cylindrically shaped. The closed end of tubular body 106 forms the second end 104 of adapter 100. Ribs 108 are attached to and extend from the outer wall of tubular body 106 and a surface (not shown) of rim 116 that is opposite to surface 120. It is to be appreciated that adapter 100 may include any number of ribs 108 distributed about the outer circumference of tubular body 106. For example, in some embodiments, the adapter 100 may include 2, 3, 4, 5, 6, 7, or 8 ribs 108. In one exemplary embodiment, the adapter 100 includes 4 ribs 108. In another exemplary embodiment, the adapter 100 includes 6 ribs 108. In yet another exemplary embodiment, the adapter 100 includes 8 ribs 108. Moreover, in some instances, ribs 108 are spaced apart equidistantly (i.e., relative to adjacent ribs 108) about the outer circumference of tubular body 106. Referring to FIGS. 2A-2D, a plurality of adapters 100 are shown in use for receiving and retaining sample collection tubes 250 in a sample collection tube rack 200 in accordance with the present technology. Sample collection tube rack 200 includes a tray portion 202 and a plurality of sample container receptacles 204 that are attached to and extend from tray portion 202. Tray receptacles 204 each include an open end 206 and a closed end 208. Open end 206 includes chamfer or beveled surface 212 (shown in FIG. 2C), which defines an aperture that provides access to interior or chamber 210 of the tray receptacles 204.

Chambers 210 may be dimensioned to receive and retain a first type of sample collection tube (not shown) having a first size and/or configuration. Adapter 100 is configured to enable each chamber 210 of sample collection tube rack 200 to receive and retain a second, different type of sample collection tube having a second size and/or configuration that is set of different than the first size or configuration. For example, the first size and/or configuration of sample collection tube may include a larger diameter than the diameter of the second type of sample collection tube. In this regard, adapter 100 is configured to enable chambers 210 of sample collection tube rack 200 to receive and retain sample collection tubes 250, which would not fit securely in tray receptacles 204 absent the adapter. Sample collection tube 250 has a significantly smaller outer diameter (e.g., twice as small) than the diameter of chambers 210 of the tray receptacles of the sample collection tube rack 200. Thus, chambers 210 would not be able to securely retain sample collection tubes 250 without the use of adapters 100 because the sample collection tubes 250 could easily fall out of any of chambers 210 during transport or tilting of sample collection tube rack 200.

In this regard, as described above, adapters 100 include features, such as beveled surfaces 110, 112, ribs 108, and the diameter of interior 118 that enable adapter 100 to interface with and be secured in a chamber 210 of sample collection tube rack 200. For example, beveled surface 112 of adapter 100 is shaped and dimensioned to correspond to the shape and dimensions of beveled surface 212. In use, end 104 of adapter 100 may be inserted into a chamber 210 of sample collection tube rack 200 until beveled surface 112 of adapter 100 contacts and is substantially aligned with a beveled surface 212 of tray receptacle 204. With beveled surface 112 and beveled surface 212 in contact an alignment, beveled surface 112 prevents adapter 100 from being inserted deeper into chamber 210 toward closed end 208. Furthermore, beveled surface 112 positions adapter 100 within chamber 210 such that a central longitudinal axis of body 106 of adapter 100 is coaxially aligned with a central longitudinal axis of tray receptacle 204.

Moreover, ribs 108 each include an edge 109 that extends in a radial direction a predetermined distance from the exterior of body 106 of adapter 100. The predetermined distance is selected such that at least a portion of the edge 109 of each rib 108 contacts the inner wall of chamber 210 to keep tubular body 106 of adapter 100 and tray receptacle 204 of sample collection tube rack 200 in coaxial alignment. In some embodiments, ribs 108 are configured to be deformable and compressible such that when adapter 100 is inserted into a chamber 210, ribs 108 are compressed between the inner wall of chamber 210 and the outer wall of tubular body 106 to create tension and friction between edges 109 of ribs 108 and the inner wall of chamber 210. The contact and tension between edges 109 and the inner wall of chamber 210 prevents the adapter 100 from being displaced out of coaxial alignment with tray receptacle 204. Furthermore, the tension and friction created between edges 109 and the inner wall of chamber 210 prevent adapter 100 from being unintentionally removed from chamber 210 or displaced along the longitudinal axis of tubular body 204 after being securely placed therein during normal use and transport of sample collection tube rack 200. It is to be appreciated that the material that ribs 108 are made of and the dimensions of ribs 108 may be selected such that, while adapter 100 is prevented from being unintentionally removed from a chamber 210 during normal use, adapter 100 may be manually removed by a user from chamber 210. In one embodiment, adapter 100 is made of Acrylonitrile Butadiene Styrene (ABS) or other material suitable for use in 3D printing to manufacture adapter 100.

The adapters described herein can be made of a variety of thermoplastic or elastomeric materials. Examples of suitable thermoplastic materials include polystyrene (PS), low density polyethylene (LDPE), high density polyethylene (HDPE), ABS, polypropylene (PP), and polylactic acid (PLA). Other material include polyurethane. Such materials can range from soft (e.g., flexible) to stiff. Such materials can have Shore A Durometer Hardness test values of about 90 to 98 (depending on the material and how it was made). Such materials can have a Shore D Durometer Hardness from the low 50's to the high 80's (depending on the material and how it was made). See Vian, Wei Dai, et al., “Hardness Comparison of Polymer Specimens Produced with Different Processes, ASEE IL-IN Section Conference 3 (2018), which is incorporated by reference herein. The adapters described herein can be molded from one material or assembled from components made of the same or different materials (e.g., the cylindrical adapter portion that receives the tube can be made of a first material and the ribs made of a second material. For example, tube 106 and rib 108 portions of the adapter may be manufactured (e.g., 3D printed) separately and assembled. Such 3D printed parts are often manufactured from polyurethane.

In one embodiment, each rib 108 includes a slot or aperture 124 (shown in FIGS. 1A, 1B) that extends in parallel with the central longitudinal axis of tubular body 104. The slot 124 is dimensioned and configured to be a relief structure that lowers the force necessary to press adapter 100 into a chamber 210 in order to obtain a press fit between adapter 100 and a receptacle 204. In this way, the slot 124 provides increased flexibility to the rib 108 allowing it to deform to facilitate the press fit of the adapter 100 into the rack 200. Typically, larger slots provide ribs that are more flexible and smaller slots provide ribs that are less flexible. The size and shape of slot 124 can therefore be selected to provide a greater manufacturing tolerance range for both the adapter 100 and the receptacle 204 of the rack 200, thereby improving manufacturability. Moreover, since the slot reduces the strain on the adapter when press fit into the rack, the slot 124 and the adapter (and also the tube 250 when retained in the adapter 100) are all less likely to crack when the adapter is press fit into the rack.

In some embodiments, ribs 108 further includes a tapered edge 111 which tapers in length from edge 109 to the outer wall of tubular body 106. When adapter 100 is being inserted into a chamber 210, tapered edge 111 is configured to guide and help position adapter 100 in chamber 210. Moreover, tapered edge 111 prevents a portion of a rib 108 from catching onto a portion of tray receptacle 204 (e.g., beveled edge 212) during insertion of adapter 100 into a chamber 210.

In one embodiment, rib edge 109 includes a protrusion 122 to increase the span of the adapter along a portion of edge 109 to further provide for an interference fit of the adapter 100 and facilitate the press fit of the adapter 100 with chamber 210 when inserted into a receptacle of the tray 200. As noted above, the rib 108 may be made of a material that is the same as or different from the material used to make the tubular body 106. It is to be appreciated that protrusion 122 may be made of a material that is softer and/or more flexible relative to the other components or parts of adapter 100 (e.g., the rib 108, the tubular body 106, etc.). For example, the portions of adapter 100 other than protrusion 122 may be made of a hard plastic, while protrusion 112 is made of a material that is softer and/or more flexible than the hard plastic.

With adapter 100 secured in chamber 210, interior 118 of adapter 100 is dimensioned to receive at least a portion of tubular body 252 of sample collection tube 250. For example, the diameter of interior 118 may be substantially the same as the outer diameter of tubular body 252 of sample collection tube 250. In one embodiment, the diameter of interior 118 is sized slightly (e.g., 1-10%) larger than the diameter of tubular body 252 received by interior 118 to enable a clearance fit between interior 118 and tubular body 252. The clearance fit is sized to allow tube 250 to be moved freely in and out of interior 118 in the vertical direction while accommodating several different size tubes 250 and maintaining tube 250 within interior 118 in a substantially vertical orientation along the central longitudinal axis of body 105. The vertical orientation enables a robot or human to pick up the tube 250 to remove the tube from interior 118 of adapter 100. Beveled surface 110 of adapter 100 is configured to guide tubular body 252 of sample collection tube 250 into interior 118 of adapter 100 when inserted therein by a robot or human.

The length of tubular body 106 of adapter 100 from first end 102 to second end 104 may be selected based on a length of tubular body 252. For example, in one embodiment, the length of tubular body 106 is selected such that at least a predetermined percentage (e.g., 50%, 60%, etc.) of the length of tubular body 252 may be retained in interior 118.

In some embodiments, multiple types of adapters 100 may be produced where the interior 118 of each type of adapter 100 has a different length and/or diameter to enable adapters 100 to receive and secure multiple different types of sample collection tubes in sample collection tube rack 200 simultaneously. For example, the interior 118 of a first adapter 100 may include a first diameter for receiving a first type of sample collection tube and a second adapter 100 may include a second diameter (different from the first diameter) for receiving a second type of sample collection tube.

In some embodiments, end 104 of adapter 100 may be configured as an open end to enable a closed end of a sample collection tube 250 received by adapter 100 to extend beyond end 104 and deeper into a chamber 210 when adapter 100 is disposed in a chamber 210.

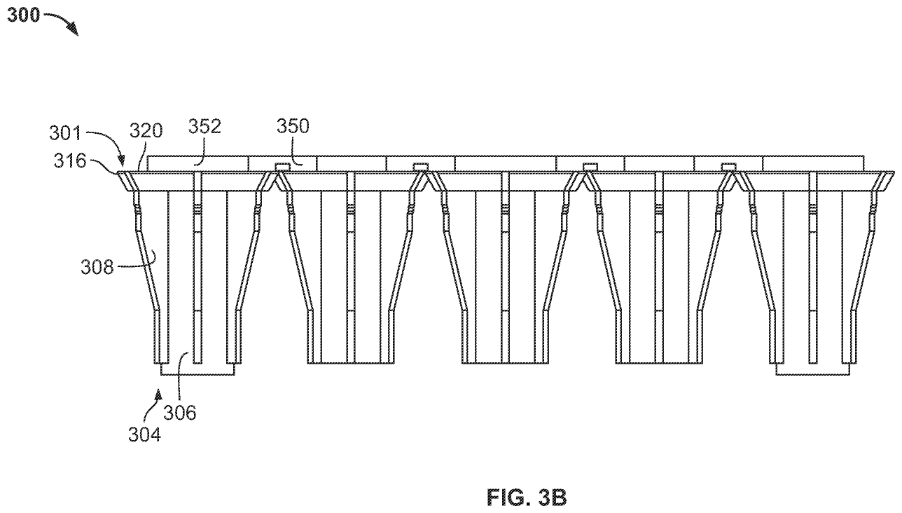

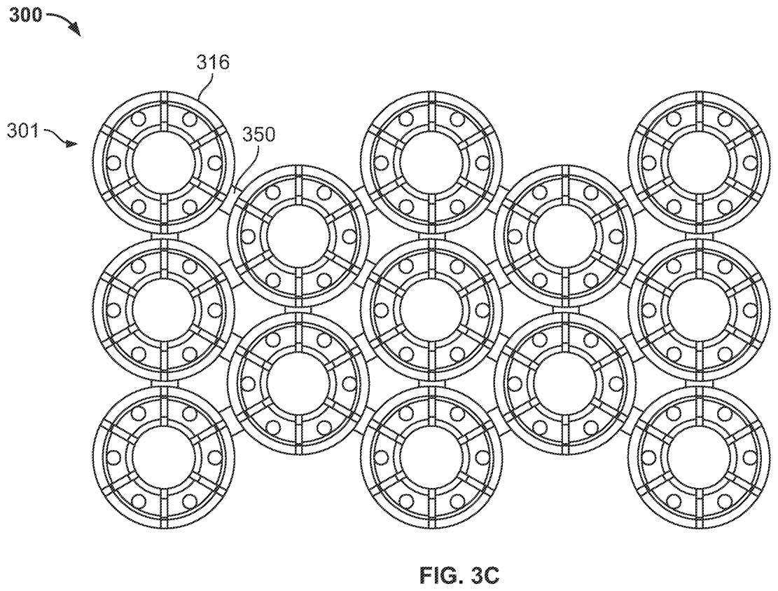

In some embodiments, a plurality of inserts, such as adapters 100, may be joined or attached to form a larger adapter apparatus capable of receiving a plurality of sample collection tubes 250 and interfacing with a sample collection tube rack 200. For example, referring to FIGS. 3A-3C an adapter 300 for use with a sample collection tube rack, such as sample collection tube rack 200, is shown in accordance with the present technology. Adapter 300 may comprise a plurality of individual adapters 301 disposed adjacently and joined by connection members 350, 352. Adapters 301 may include any of the features described above with respect to adapters 100 for storing sample collection tubes 250 in sample collection tube rack 200. For example, adapters 301 each include ends 302, 304, tubular body 306, rim 316, and ribs 308, which may be configured in the manner described above with respect to ends 101, 102, tubular body 106, rim 116, and ribs 308. Thus, each adapter 301 is configured to receive and store a sample collection tube 250 in a sample collection tube rack 200.

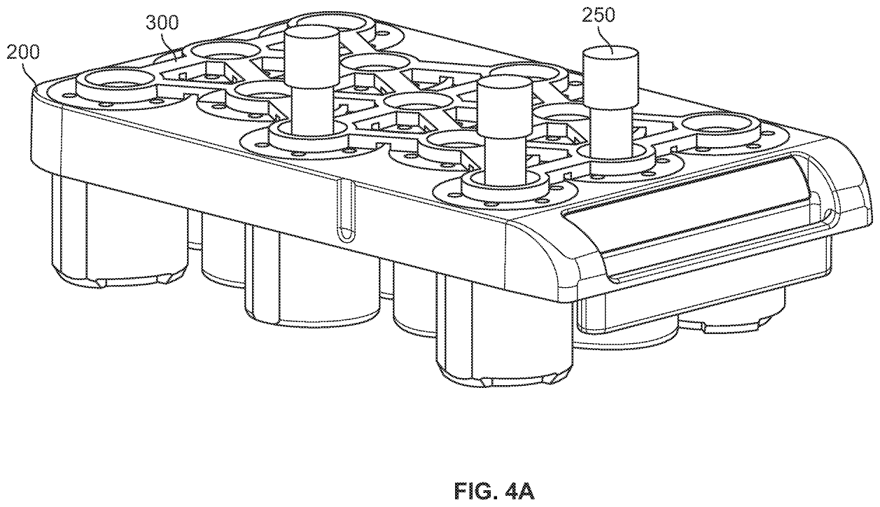

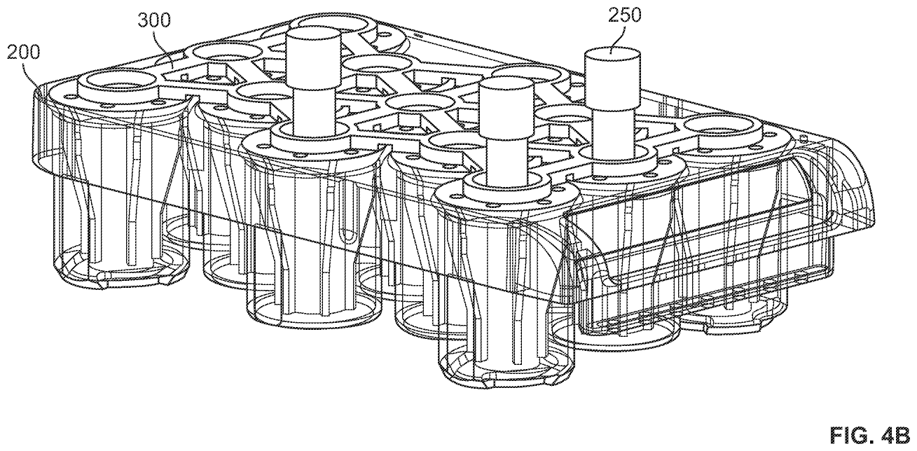

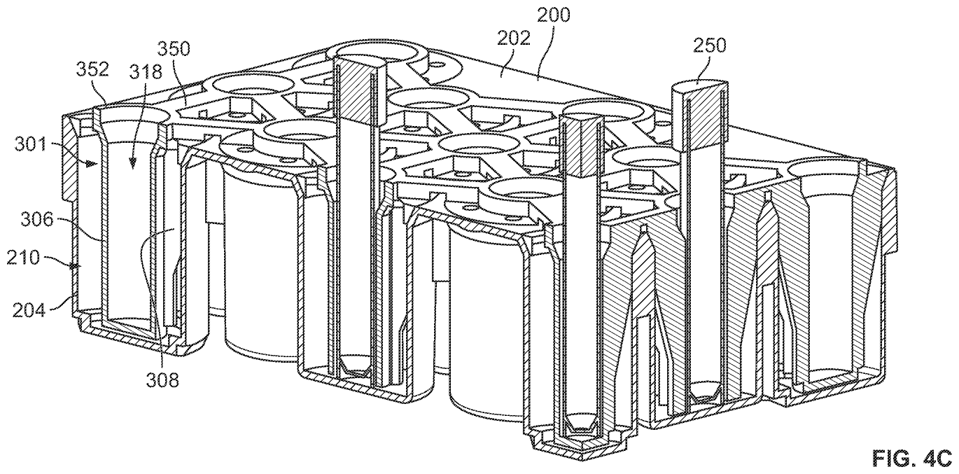

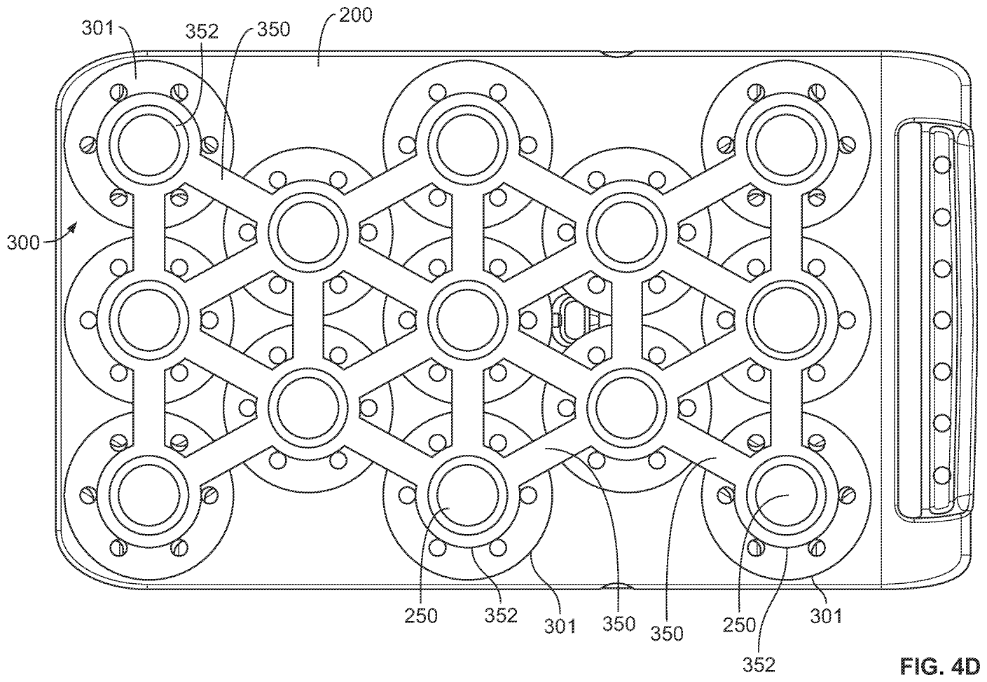

In one embodiment, each connection member 352 is configured in a ring shape and is attached to a surface 320 of a rim 316 of an adapter 301 such that an aperture 354 of connection member 352 is coaxially aligned with an opening 310 of rim 316 to enable insertion of a sample collection tube 250 into the interior of an adapter 301. Each connection member 352 of each adapter 301 is attached to at least one other connection member 352 of another adapter 301 via a connection member 350. A portion of each connection member 350 may also be attached to a portion of surfaces 320 of adjacent adapters 301. Each connection member 350 has an elongate shape. In one embodiment, each connection member 350 includes a portion 356 disposed centrally between the ends of connection member 350 that has a smaller cross-section than the remainder of connection member 350. In other words, portion 356 of connection member 350 provides a structurally weaker portion because of the connection member is thinner in this location. In this way, portion 356 enables adjacent adapters 301 to more easily be tilted or bent with respect to each other to aid in positioning each of adapters 301 in corresponding chambers 210 of a sample collection tube rack 200. Referring to FIGS. 4A-4D, adapter 300 is shown in use for receiving and retaining sample collection tubes 250 in a sample collection tube rack 200 in accordance with the present technology. As shown in FIGS. 3A-3B and 4C, adapters 301 are connected adjacently via connection members 350, 352, such that adapters 301 align with chambers 210 of tubular bodies 204 of sample collection tube rack 200. With adapters 301 securely positioned in corresponding chambers 210, sample collection tubes 250 may be inserted into interiors 318 (shown in FIG. 4C) of adapters 301. The position of connection members 350, 352 above surfaces 320 of rims 316 of each adapter 301 enables connection members 350, 352 to extend without obstruction across the top surface of tray portion 202 of sample collection tube rack 200.

Adapter 300 and rack 200 may be submerged in a cleaning solution (e.g., a bleach solution) between uses to clean adapter 300 and rack 200. Thereafter, adapter 300 and rack 200 may be placed upside down for drying. In one embodiment, each adapter 301 includes one or more apertures or bores 321 disposed through surface 321 in rim 316. The apertures 321 may be distributed equidistantly relative to adjacent apertures 321 around rim 316. Apertures 321 enable the cleaning solution to drain from the chambers of rack 200 when adapter 300 and rack 200 are placed upside down for drying. Moreover, the portion 356 enables any cleaning solution disposed between connection member 350 and rack 200 to drain away after adapter 300 and rack 200 has been submerged in the cleaning solution and then removed from the cleaning solution and set upside down to dry.

It is to be appreciated that adapter 300 may be removed from rack 200 and submerged in the cleaning solution separately from rack 200 for cleaning adapter 300. Thereafter, adapter 300 is placed upside down for drying. Apertures 321 and portion 356 enable the cleaning solution to drain from adapter 300 and prevents pooling of the cleaning solution during drying.

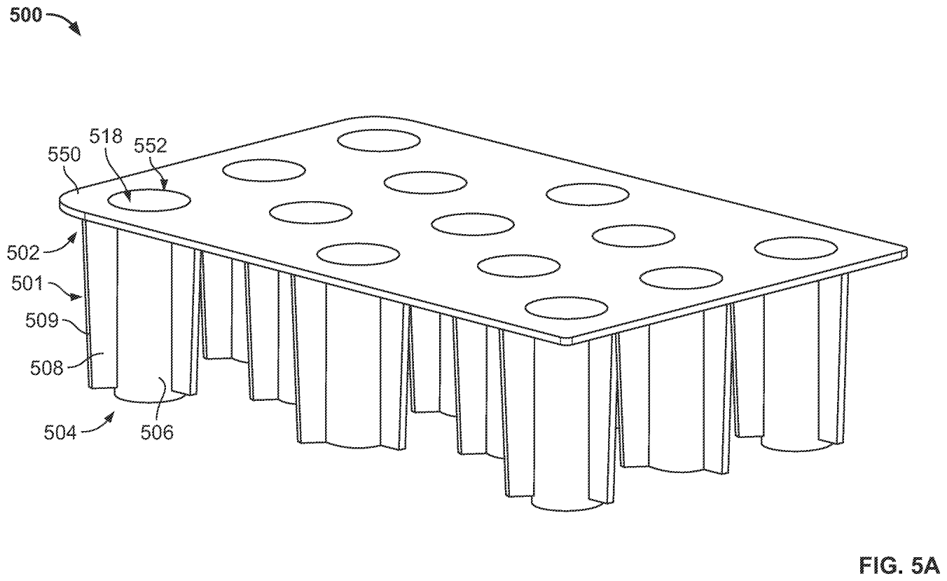

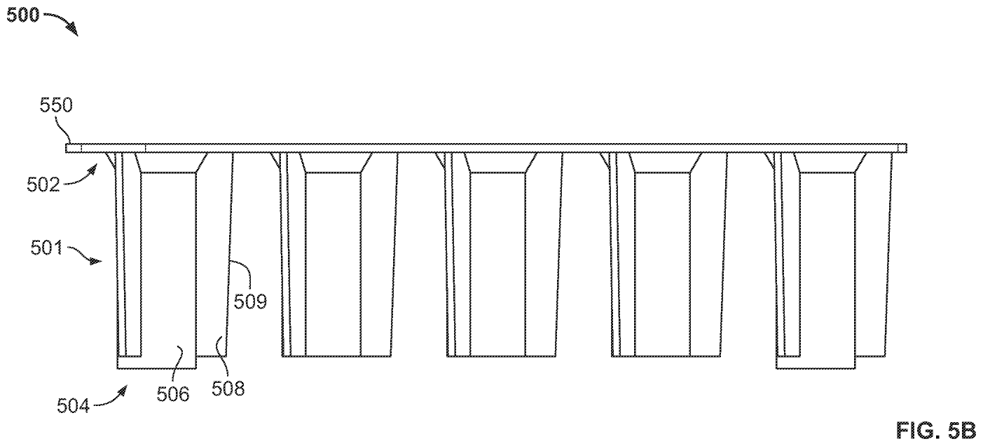

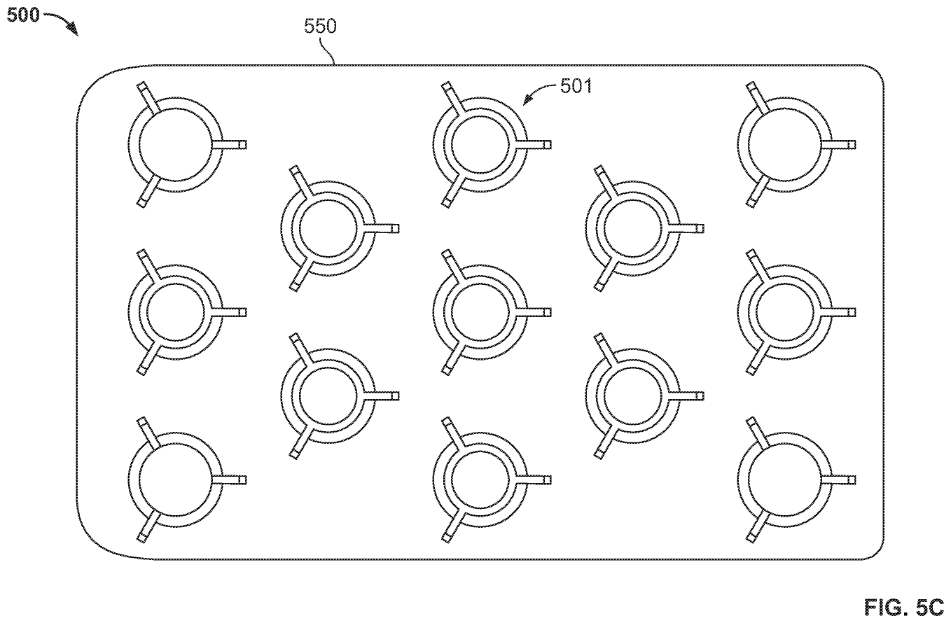

In another embodiment, rather than using connection members 350, 352 to join the plurality of adapters 301 to form one large adapter 300, the plurality of adapters 301 may be connected by a single sheet of material. For example, referring to FIGS. 5A-5C an adapter 500 including a connection sheet 550 for connecting a plurality of adapters 501 is shown in accordance with the present technology. Adapters 501 may include any of the features of adapters 100, 301 described above. Thus, each adapter 501 is configured to receive and store a sample collection tube 250 in a sample collection tube rack 200. In this embodiment, ribs 508 include a substantially linear edge 509 that tapers from end 502 to end 504 of adapter 501. The extent to which the rib 508 extends along the exterior of tubular body 506 is selected to prevent warp and misalignment of tubular body 506. In one embodiment, rib 508 extends 80 percent to 95 percent of the length of tubular body 506 but typically does not extend the entire length of the tubular body 506 to ensure that the rib does not interfere with the insertion of the tubular body 506 in the tray receptacle.

Connection sheet 550 includes a plurality of apertures 552. Adapters 501 are adjacently attached to and extend from sheet 550 such that the apertures 552 coaxially align with the respective openings in adapters 501 to provide access to the interior 518 of each adapter 501. As best seen in FIG. 5B, connection sheet 550 is attached to a rim formed in the ends 502 of each adapter 501, where the rim of each insert may include similar features to rim 116 described above.

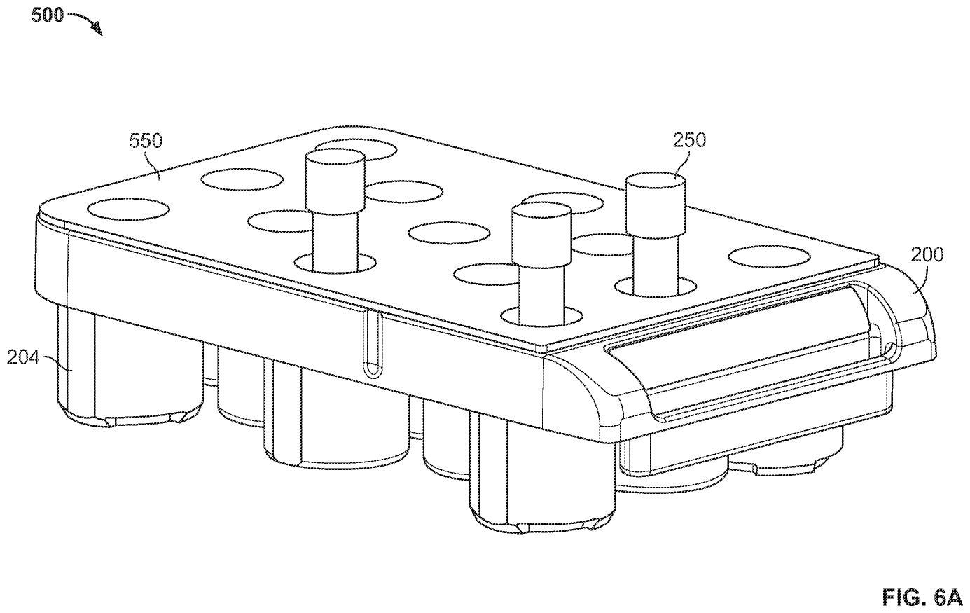

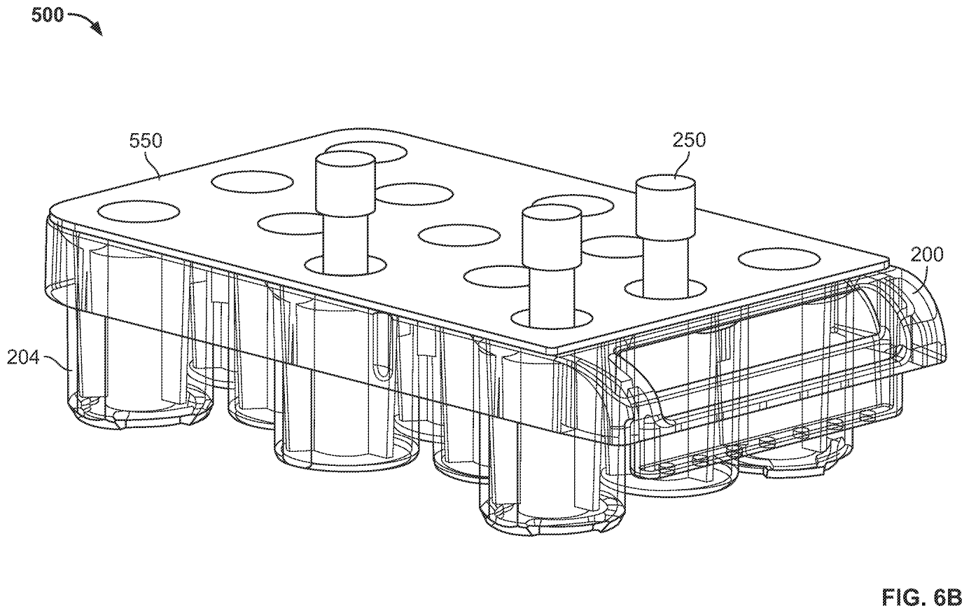

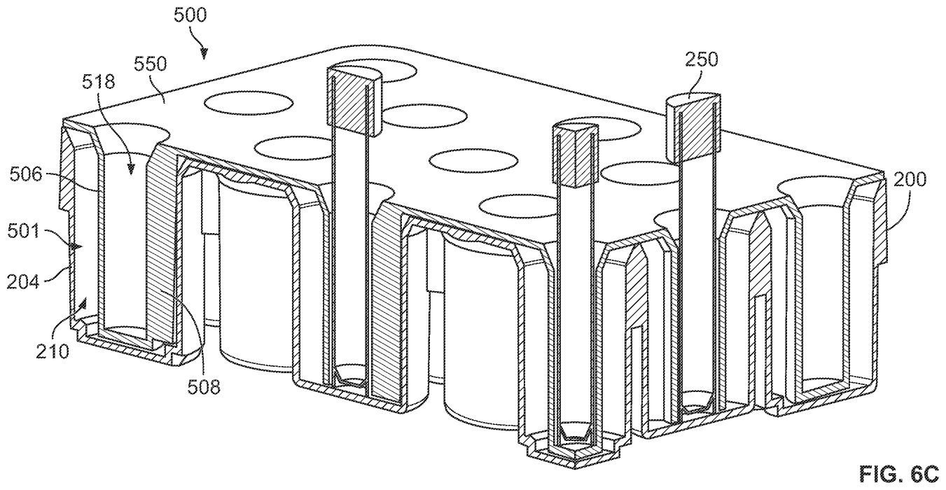

Referring to FIGS. 6A-6C, adapter 500 is shown in use for receiving and retaining sample collection tubes 250 in a sample collection tube rack 200 in accordance with the present technology. As shown in FIGS. 6A-6C, adapters 501 are connected adjacently via connection sheet 550 such that adapters 501 align with chambers 210 of tubular bodies 204 of sample collection tube rack 200. Connection sheet 550 is configured to be bendable to enable adapters 501 to be tilted with respect to each other for positioning and insertion of adapters 501 into corresponding chambers 210 of sample collection tube rack 200. When adapters 501 are inserted into corresponding chambers 210, the edges 509 of ribs 508 contact the inner walls of chambers 210 to securely retain adapters 501 in chambers 210 and coaxially align adapters 501 with chambers 210. The taper of each edge 509 is such that as each adapter 501 is advanced further into chamber 210 the fit between each adapter 501 and chamber 210 becomes more secure. With adapters 501 securely positioned in corresponding chambers 210, sample collection tubes 250 may be inserted into interiors 518 of adapters 501. Connection sheet 550 is positioned across each of the ends 502 of adapters 501 to enable connection sheet 550 to sit against tray portion 202 of sample collection tube rack 200.

In one embodiment, the taper of each edge 509 is such that edge 509 only contacts the inner wall of chamber 210 along a top portion of edge 509 near sheet 550 and the remainder of edge 509 does not contact the inner wall of chambers 210. In this way, forces for the press fit of each adapter 501 into a chamber 210 is reduced and the material stresses are also reduced.

Although adapters 300 and 500 described above are shown as including an equal number of adapters 301, 501 to the number of chambers in the sample collection tube rack 200, in other embodiments, adapters 300 and 500 may be configured to include a number of adapters 301, 501 that is less than the total number of chambers 210 in sample collection tube rack 200. For example, adapters 300 and 500 may be configured such that adapters 301, 501 fill only a subset (e.g., a quarter, half, or any other proportion) of adjacent chambers 210 in a sample collection tube rack 200. In this way, the remaining unfilled chambers 210 in a sample collection tube rack 200 may be used with individual adapters 100 made for differently dimensioned sampled collection tubes and/or the original sample collection tubes that sample collection tube rack 200 was designed for.

In some embodiments, the dimensions of different adapters 301, 501 of adapters 300, 500 may differ to enable a single adapter 300 or 500 to retain different types of sample collection tubes. For example, at least one adapter 301/501 of an adapter 300/500 may include a first diameter to receive a sample collection tube of a first type and at least one second adapter 301/501 of the adapter 300/500 may include a second diameter for receiving a second type of sample collection tube. It is to be appreciated that the lengths of the tubular bodies of adapters 301/501 may also vary within the same adapter 300/500 to accommodate different types of sample collection tubes.

In one embodiment, the tubular bodies 204 disposed at the corners of sample collection tube rack 200 may be dimensioned such that the closed ends 208 of these tubular bodies 204 extend further from tray portion 202 than the remaining tubular bodies 204 not disposed at the corners of sample collection tube rack 200. Referring to FIGS. 3B, 4C, 5A, 5B, and 6C, in this embodiment, the adapters 301 and 501 of adapters 300 and 500 that correspond in position to the chambers 210 at the corners of sample collection tube rack 200 may be longer from ends 302/502 to 304/504 that corresponds to the larger length or depth of chambers 210 at the corners of sample collection tube rack 200.

In some embodiments, the ends 304/504 of some of adapters 301/501 may be configured as open ends to enable a closed end of a sample collection tube 250 received by adapter 301/501 to extend beyond end 304/504 and deeper into a chamber 210 when adapter 301/501 is disposed in a chamber 210. Furthermore, the open ends 304/504 of adapters 301/501 allow the user to clean and dry the rack 200 without the need to remove the adapters 301/501 from the rack 200.

It is to be appreciated, as noted elsewhere herein, that any of the adapters 100, 300, 500 described above may be made of the same material and/or molded or otherwise manufactured as a single piece. Alternatively, adapters 100, 300, 500 can be assembled where different parts (e.g., the tubular body 106, the ribs 108) are made of different materials. Such adapters 100, 300, 500 may be manufactured (e.g., 3D printed) separately and assembled.

As noted above, adapters 100, 300, or 500 may be made of a material that is rigid or flexible. Alternatively, a portion (e.g., ribs 108, 308, 508, and/or any other portion) of adapters 100, 300, or 500 may be made of a material that is rigid or flexible. In one example, for a 3D printed part, the main structure of the adapter (e.g., the tubular body 106) could be printed to be more rigid and the ribs (e.g., 108, 308, 508) could be printed to be more flexible. Also, the connecting members or connecting sheets can be formed to be more flexible while the tubular body is formed from a more rigid material. Depending on the 3D printer, rigid and more flexible materials can be either the same material (but with different properties) or different materials with different properties.

It is to be appreciated that any of the adapters 100, 300, 500 described above may be inserted into chambers 210 of a sample collection tube rack 200 during manufacture of sample collection tube rack 200. Alternatively, adapters 100, 300, 500 may be inserted into chambers 210 of a sample collection tube rack 200 by a user prior to use of sample collection tube rack 200 for storing sample collection tubes 250.

It is to be appreciated that any of adapters 100, 300, 500 described above may be made such that they are disposable. This may be useful to prevent the need for a user to clean sample collection tube racks 200 and/or adapters 100, 300, 500. Alternatively, adapters 100, 300, 500 may be made to be durable and reusable.

From the foregoing and with reference to the various figure drawings, those skilled in the art will appreciate that certain modifications can also be made to the present disclosure without departing from the scope of the same. While several embodiments of the disclosure have been shown in the drawings, it is not intended that the disclosure be limited thereto, as it is intended that the disclosure be as broad in scope as the art will allow and that the specification be read likewise. Therefore, the above description should not be construed as limiting, but merely as exemplifications of particular embodiments. Those skilled in the art will envision other modifications within the scope and spirit of the claims appended hereto.

1. An adapter comprising:
a first end and a second end;
a tubular body extending from the first end to the second end and including an interior; and
a rim formed on the first end of the adapter and including a first beveled surface and an aperture providing access to the interior of the tubular body, the interior of the tubular body dimensioned to receive and retain a tube,
wherein when the second end of the adapter is inserted into a chamber of a receptacle of a tube rack, the first beveled surface is configured to contact a beveled surface defining an opening of the receptacle to position the adapter in coaxial alignment with the chamber.

2. The adapter of claim 1, wherein the rim includes a second beveled surface defining the aperture, the second beveled surface is configured to guide the tube into the interior of the tubular body.

3. The adapter of claim 1, further comprising at least one rib extending from an outer wall of the tubular body toward an exterior of the adapter, wherein at least a portion of the at least one rib is configured to contact an interior wall of the chamber of the tube rack to maintain the coaxial alignment between the adapter and the chamber and retain the adapter in the chamber.

4. The adapter of claim 3, wherein the at least one rib includes a first edge extending in parallel with a central longitudinal axis of the tubular body, wherein at least a portion of the first edge is configured to contact the interior wall of the chamber of the tube rack.

5. The adapter of claim 4, wherein the at least one rib includes a second edge that tapers from the first edge to the outer wall of the tubular body, the second edge is configured to guide the adapter into the chamber of the tube rack.

6. The adapter of claim 3, wherein the at least one rib is a deformable rib comprising a slot.

7. The adapter of claim 3, wherein the at least one rib comprises a plurality of ribs spaced apart equidistantly about an outer circumference of the tubular body.

8. The adapter of claim 1, wherein the chamber of the tube rack has a first diameter for receiving a first type of tube and the interior of the adapter has a second diameter for receiving a second type of tube, wherein the first diameter is larger than the second diameter.

9. The adapter of claim 1, wherein the first beveled surface of the adapter is shaped to correspond to a shape of the beveled surface of the receptacle of the tube rack.

10. The adapter of claim 1, wherein the tube is a sample collection tube and the tube rack is a sample collection tube rack.

11. The adapter of claim 1, wherein the adapter is made of a thermoplastic.

12. The adapter of claim 11, wherein the thermoplastic is selected from the group consisting of polystyrene (PS), low density polyethylene (LDPE), high density polyethylene (HDPE), Acrylonitrile Butadiene Styrene (ABS), polypropylene (PP), and polylactic acid (PLA).

13. The adapter of claim 11, wherein a least a portion of the adapter is made of a rigid thermoplastic.

14. The adapter of claim 11, wherein at least a portion of the adapter is made of a flexible thermoplastic.

15. The adapter of claim 3, wherein the tubular body, the rim, and the rib are made of the same of different materials.

16. An apparatus comprising:
a plurality of adapters, each adapter of the plurality of adapters comprising:
a first end and a second end,
a tubular body extending from the first end to the second end and including an interior,
a rim formed on the first end of the adapter and including an entry aperture providing access to the interior of the tubular body, the interior of the tubular body dimensioned to receive and retain a tube; and
at least one connection member that joins the plurality of adapters such that each adapter of the plurality of adapters align with and is insertable into a chamber of a corresponding receptacle of a tube rack.

17. The apparatus of claim 16, wherein the tube is a sample collection tube and the tube rack is a sample collection tube rack.

18. The apparatus of claim 16, wherein the rim of each adapter includes a first beveled surface and the second end of each adapter is configured for insertion into a corresponding chamber of the tube rack, the first beveled surface of each adapter is configured to contact a corresponding beveled surface of each receptacle to position each adapter in coaxial alignment with the corresponding chamber in the tube rack.

19. The apparatus of claim 18, wherein the rim of each adapter includes a second beveled surface disposed around the entry aperture, the second beveled surface being configured to guide the tube into the interior of the tubular body when inserted therein.

20. The apparatus of claim 18, wherein each adapter comprises:
at least one rib extending from an outer wall of the tubular body toward an exterior of the adapter and wherein at least a portion of the at least one rib is configured to contact an interior wall of the corresponding chamber and to maintain the coaxial alignment between the adapter and the chamber and to retain the insert in the chamber.

21. The apparatus of claim 20, wherein the adapter comprises a plurality of ribs spaced apart about an exterior portion of the tubular body.

22. The apparatus of claim 20, wherein the adapter comprises a plurality of ribs spaced apart equidistantly about an exterior portion of the tubular body.

23. The apparatus of claim 19, wherein the at least one connection member is a sheet of material that connects the plurality of adapters.

24. The apparatus of claim 23, wherein the sheet is flexible.

25. The apparatus of claim 23, wherein the rim of each adapter includes a beveled surface disposed around the aperture, the beveled surface is configured to guide the tube into the interior of the tubular body.

26. The apparatus of claim 16, wherein each chamber of the tube rack includes a first diameter for receiving a first type of tube and the interior of the tubular body of each adapter includes a second diameter for receiving a second type of tube, wherein the first diameter is larger than the second diameter.

27. The apparatus of claim 20, wherein the tubular body, the rim, the connection member and the rib are made of the same or different materials.

28. The adapter of claim 16, wherein the adapter is made of a thermoplastic.

29. The adapter of claim 28, wherein the thermoplastic is selected from the group consisting of polystyrene (PS), low density polyethylene (LDPE), high density polyethylene (HDPE), Acrylonitrile Butadiene Styrene (ABS), polypropylene (PP), and polylactic acid (PLA).
